(19) United States
(12) Patent Application Publication
(10) Pub. No.: US 2026/0158507 A1
(43) Pub. Date: Jun. 11, 2026

(54) NOZZLE ATTACHMENT SYSTEM

(71) Applicant: Airgas, Inc., Radnor, PA (US)

(72) Inventors: Stephen BILGER, Houston, TX (US); William ADAMS, Houston, TX (US)

(21) Appl. No.: 18/973,755

(22) Filed: Dec. 9, 2024

(51) Int. Cl. B05B 1/30; B05B 15/60

(52) U.S. Cl. CPC B05B 1/30; B05B 15/60

(57) ABSTRACT

A nozzle attachment system, including a hose attachment having an attachment face, an internal diameter recess, and a hose attachment feature. A nozzle having a nozzle flange, and a nozzle internal diameter. And a housing comprising a housing flange, and a housing flange face. Wherein the nozzle is configured to fit inside the housing during assembly. Wherein the nozzle flange is configured to fit inside the internal diameter recess. Wherein the hose attachment feature is configured to fit inside the nozzle internal diameter. Wherein the nozzle flange and the housing flange are adjacent during assembly. And wherein the attachment face and the housing flange face are adjacent during assembly.

### BACKGROUND

Rotary mixers are often utilized to mix food compositions including poultry, meat, fish, etc., in a vessel prior to forming the food composition into shapes, such as nuggets or patties. In order to obtain adequate consistency and viscosity such that the food composition remains in the formed shape, it is advantageous to cool the food composition. Coolants are typically used to cool the food composition. However, there remains a need for improved nozzle assemblies for dispersing coolant, such as nozzle assemblies offering the advantages of the present invention, which will become apparent from the description of the invention provided herein and the appended drawings.

### SUMMARY

A nozzle attachment system, including a hose attachment having an attachment face, an internal diameter recess, and a hose attachment feature. A nozzle having a nozzle flange, and a nozzle internal diameter. And a housing comprising a housing flange, and a housing flange face. Wherein the nozzle is configured to fit inside the housing during assembly. Wherein the nozzle flange is configured to fit inside the internal diameter recess. Wherein the hose attachment feature is configured to fit inside the nozzle internal diameter. Wherein the nozzle flange and the housing flange are adjacent during assembly. And wherein the attachment face and the housing flange face are adjacent during assembly.

### BRIEF DESCRIPTION OF THE FIGURES

For a further understanding of the nature and objects for the present invention, reference should be made to the following detailed description, taken in conjunction with the accompanying drawings, in which like elements are given the same or analogous reference numbers and wherein:

FIG. 1 is a schematic representation of a nozzle assembly, as is known in the art.

FIG. 2 is a schematic representation of a hose attachment for a nozzle assembly, as is known in the art.

FIG. 3a is a schematic representation of a housing/nozzle assembly as is known in the art.

FIG. 3b is another schematic representation of a housing/nozzle assembly as is known in the art.

FIG. 4 is a schematic representation of a nozzle assembly as is known in the art.

FIG. 5a is a schematic representation of a hose attachment for a nozzle with a nipple, in accordance with one embodiment of the present invention.

FIG. 5b is a schematic representation of a hose attachment for a nozzle with a nipple, in accordance with one embodiment of the present invention.

FIG. 6a is a schematic representation of a hose attachment for a nozzle with a check valve, in accordance with one embodiment of the present invention.

FIG. 6b is a schematic representation of a hose attachment for a nozzle with a check valve, in accordance with one embodiment of the present invention.

FIG. 7a is a schematic representation of a hose attachment for a nozzle with a spray nozzle, in accordance with one embodiment of the present invention.

FIG. 7b is a schematic representation of a hose attachment for a nozzle with a spray nozzle, in accordance with one embodiment of the present invention.

FIG. 8a is a schematic representation of a hose attachment for a nozzle with a combined spray nozzle and check valve, in accordance with one embodiment of the present invention.

FIG. 8b is a schematic representation of a hose attachment for a nozzle with a combined spray nozzle and check valve, in accordance with one embodiment of the present invention.

FIG. 9 is a schematic representation of a nozzle assembly, in accordance with one embodiment of the present invention.

FIG. 10 is a schematic representation of a nozzle assembly, in accordance with one embodiment of the present invention.

### ELEMENT NUMBERS

101=housing
102=proximal end portion
103=distal end portion
104=nozzle
105=housing flange
106=reusable clamp
107=nozzle flange
108=hose attachment
109=washer
201=attachment face
202=face inside diameter
203=body internal diameter
301=nozzle outside diameter
302=housing internal diameter
303=nozzle flange face
304=nozzle flange diameter
305=nozzle inside diameter
401=first face (of washer)
402=second face (of washer)
403=washer internal diameter
404=housing flange face
501=nipple
502=internal diameter recess face
503=engagement distance
601=check valve
602=internal diameter recess
603=engagement distance
701=spray nozzle
702=internal diameter recess
703=engagement distance
801=combined spray nozzle and check valve
802=internal diameter recess
803=engagement distance
901=hose attachment feature
902=vessel

### DESCRIPTION OF PREFERRED EMBODIMENTS

Illustrative embodiments of the invention are described below. While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

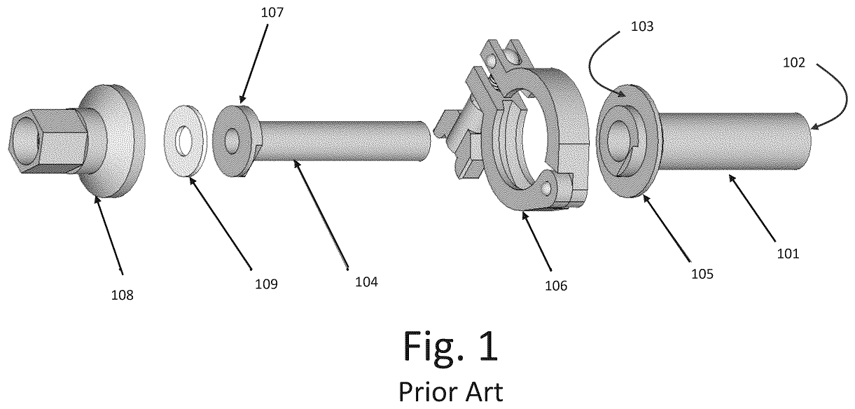

The overall nozzle assembly has been previously described in U.S. Pat. No. 10,518,286, which is incorporated herein by this reference. Referring to present FIG. 1, housing 101 has a proximal end portion 102 and a distal end portion 103 spaced from the proximal end portion 102. Although the housing 101 is illustrated as having a cylindrical shape, housing 101 may have a shape that is non-cylindrical, such as a rectangular, square, pyramidal, or other geometric shape. In one embodiment, the shape of the housing is non-geometric.

The distal end portion 103 of the housing 101 may have an end that is adapted for coupling, directly or indirectly, to the nozzle 104. For example, the distal end portion 103 may include housing flange 105 for coupling or securing the housing 101 to another component of the nozzle assembly (e.g., using reusable clamp 106) to restrict axial displacement of the housing 101 relative to the other component(s) of the nozzle assembly along the longitudinal axis of the housing 101.

Nozzle 104 is adapted for coupling to housing 101. The nozzle 104 may have nozzle flange 107 configured for coupling the nozzle 104 to the distal end portion 103 of housing 101. Nozzle 104 may be connected to hose attachment 108 by reusable clamp 106. Washer 109 may be positioned adjacent to hose attachment 108, creating a seal between the hose attachment 108 and the washer 109 and between the washer 109 and nozzle 104. One of ordinary skill in the art would recognize based on the description herein that other methods and manners for attaching the base portion of the nozzle to a hose and/or a coolant source may be readily used without deviating from the spirit and scope of the invention.

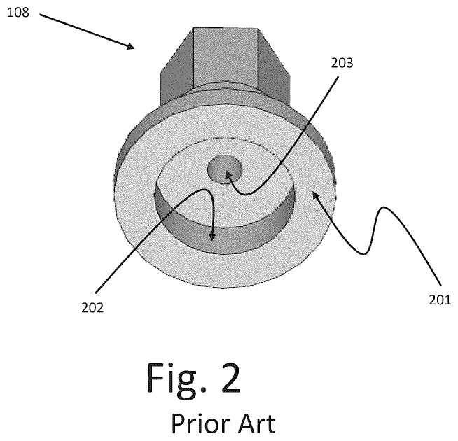

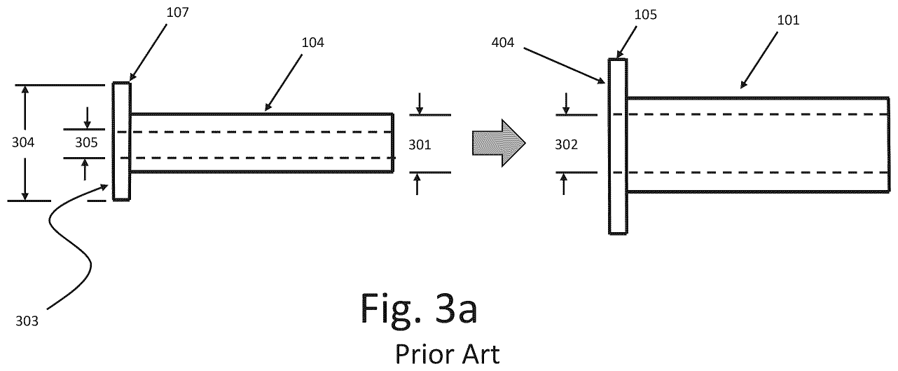

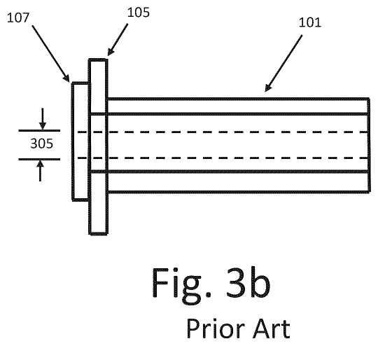

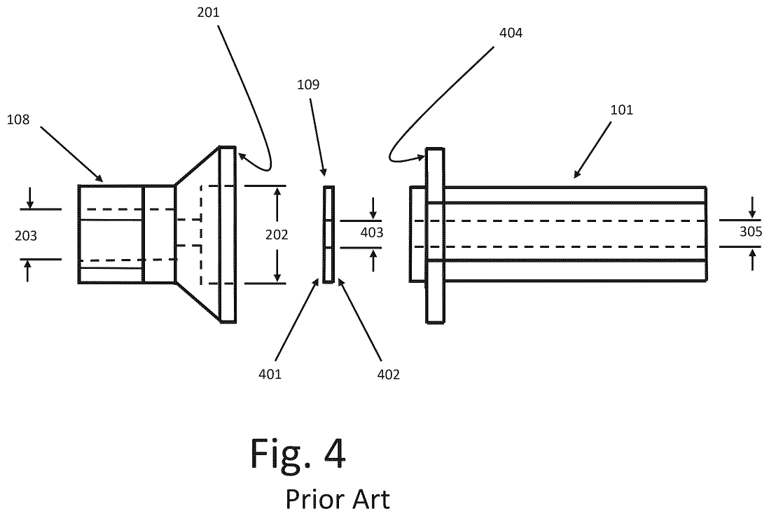

Turning to FIG. 2, FIG. 3a, FIG. 3b, and FIG. 4, hose attachment 108 as disclosed in U.S. Pat. No. 10,518,286 is illustrated. Hose attachment 108 has attachment face 201, face inside diameter 202, and body internal diameter 203. Washer 109 has first face 401, second face 402, and washer internal diameter 403.

Nozzle 104 has nozzle flange 107, nozzle inside diameter 305, nozzle flange face 303, nozzle flange diameter 304, and nozzle outside diameter 301. Nozzle flange diameter 304 being slightly smaller than face inside diameter 202. Housing 101 has housing flange face 404, housing flange 105, and housing internal diameter 302. As shown in FIG. 3b, nozzle 104 slides into housing 101, with the nozzle outside diameter 301 being slightly smaller than housing internal diameter 302. When in place, housing flange 105 is in contact with nozzle flange 107. When assembled, attachment face 201 is in sealed contact with first face 401. When assembled, washer 109 and nozzle flange 107 fit inside face inside diameter 202 and is in contact with nozzle flange face 303. The thickness of washer 109 plus nozzle flange 107 is slightly greater than the depth of the recess created by face inside diameter 202 depth, so housing flange face 404 does not touch attachment face 201 when assembled. Reusable clamp 106 squeezes attachment face 201 and housing flange face 404 together to create a seal when tightened.

When assembled, nozzle internal diameter 305 and body internal diameter 203 are fluidly aligned. As described with respect to FIG. 1, the entire assembly is then held in place by reusable clamp 106 (not shown in FIG. 2 or FIG. 3). Thus, when assembled, fluid entering hose attachment 1082 of housing 101, passes through nozzle 104, and exits into vessel 902. While simple in design, this design may allow fluid to inadvertently escape past washer 109 and/or reusable clamp 106.

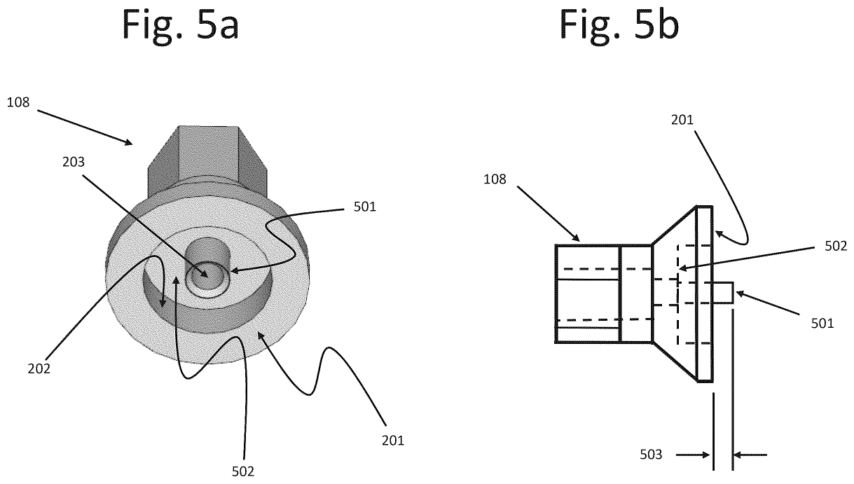

The present invention is an improvement on the design of hose attachment 108. Turning to FIG. 5a and FIG. 5b, one embodiment of hose attachment 108 in accordance with the present invention is illustrated. Hose attachment 108 has attachment face 201, face inside diameter 202, and internal diameter recess face 502. Hose attachment 108 includes nipple 501 and body internal diameter 203, which is concentric with nipple 501. Nipple 501 extends axially from internal diameter recess face 502 and extends from attachment face 201 by engagement distance of 503. Engagement distance 503 may be below, at, or beyond the level of attachment face 201. In FIG. 5b, discussed below, it is shown to be beyond attachment face 201.

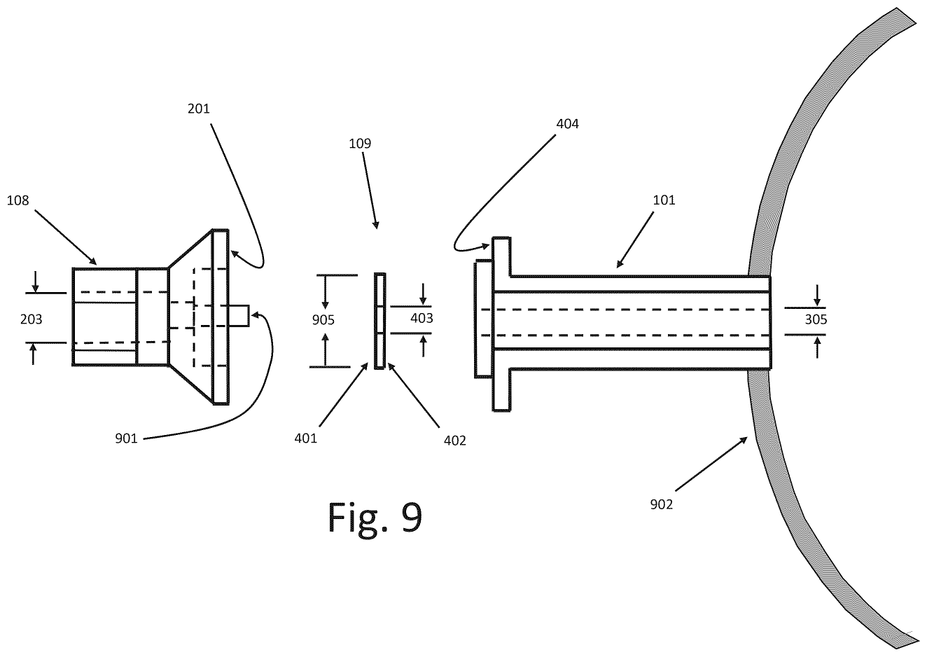

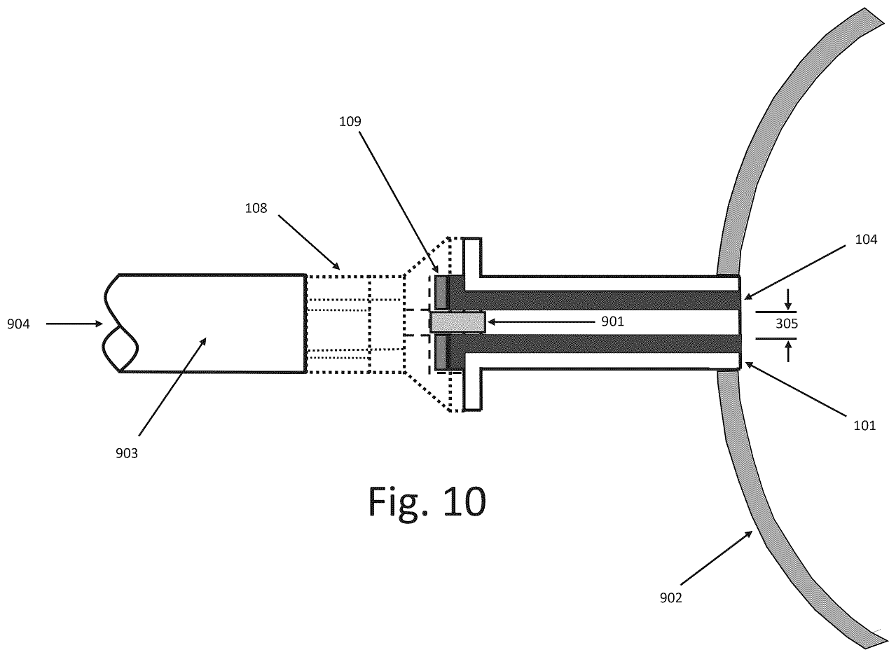

Nipple 501 may be machined into hose attachment 108, or it may be attached by means of threading, bonding, or welding. Nipple 501 may be 3-D printed along with the entire hose attachment 108. Nipple 501 improves the sealing between hose attachment 108, washer 109, and housing 101, as discussed below in FIG. 9 and FIG. 10.

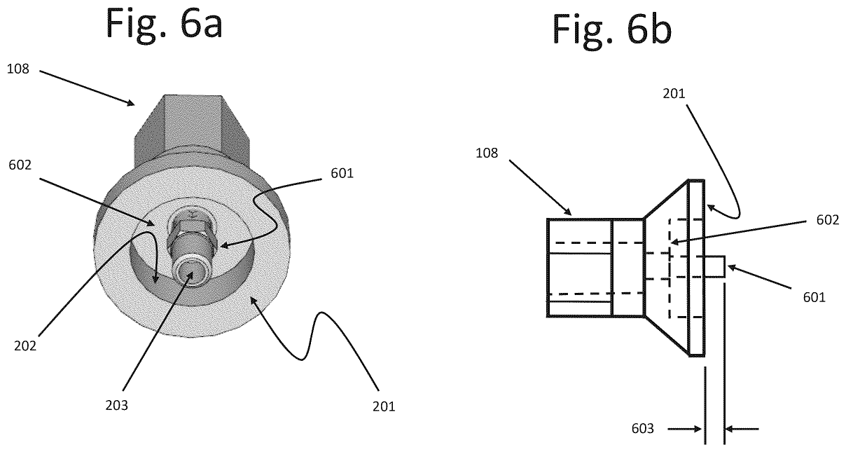

Turning to FIG. 6a and FIG. 6b, one embodiment of hose attachment 108 in accordance with the present invention is illustrated. Hose attachment 108 has attachment face 201, face inside diameter 202, and internal diameter recess 602. Hose attachment 108 includes check valve 601 and body internal diameter 203, which is concentric with check valve 601. Check valve 601 extends axially from internal diameter recess 602 and extends from attachment face 201 by engagement distance of 603. In an alternative embodiment, engagement distance 603 may be negative (i.e. check valve 601 does not extend beyond the level of attachment face 201). In another alternative embodiment, not shown, engagement distance 603 may be zero (i.e. check valve 601 is at the level of attachment face 201). As shown in FIG. 6b, engagement distance 603 is positive (i.e. check valve 601 extends beyond the level of attachment face 201).

Check valve 601 may be machined into hose attachment 108, or it may be attached by means of threading, bonding, or welding. Check valve 601 may be 3-D printed along with the entire hose attachment 108. The body of check valve 601 improves the sealing between hose attachment 108, washer 109, and housing 101, as discussed below in FIG. 9 and FIG. 10. Check valve 601 also prevents coolant and any other contents of vessel 902 to which the nozzle is attached, from returning back through hose attachment 108.

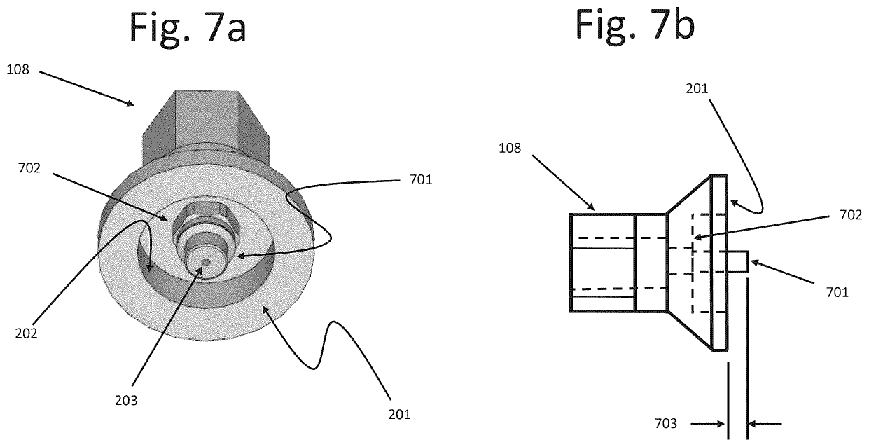

Turning to FIG. 7a and FIG. 7b, another embodiment of hose attachment 108 in accordance with the present invention is illustrated. Hose attachment 108 has attachment face 201, face inside diameter 202, and internal diameter recess 702. Hose attachment 108 includes spray nozzle 701 and body internal diameter 203, which is concentric with spray nozzle 701. Spray nozzle 701 extends axially from internal diameter recess 702 and extends from attachment face 201 by engagement distance of 703. In an alternative embodiment, not shown, engagement distance 703 may be negative (i.e. spray nozzle 701 does not extend beyond the level of attachment face 201). In another alternative embodiment, engagement distance 703 may be zero (i.e. spray nozzle 701 is at the level of attachment face 201). As shown in FIG. 7b, engagement distance 703 is positive (i.e. spray nozzle 701 extends beyond the level of attachment face 201).

Spray nozzle 701 may be machined into hose attachment 108, or it may be attached by means of threading, bonding, or welding. Spray nozzle 701 may be 3-D printed along with the entire hose attachment 108. The body spray nozzle 701 improves the sealing between hose attachment 108, washer 109, and housing 101, as discussed below in FIG. 9 and FIG. 10. Spray nozzle 701 also provides a more precise, or calibrated, flow than nipple 501, for better control of the chilling process. Spray nozzle 701 may also be configured to produce a spray with a flat cone, or any other shape to enhance the cleaning of the sanitary nozzle inner walls (housing internal diameter) 305 and to enhance the dispersal of coolant into vessel 902.

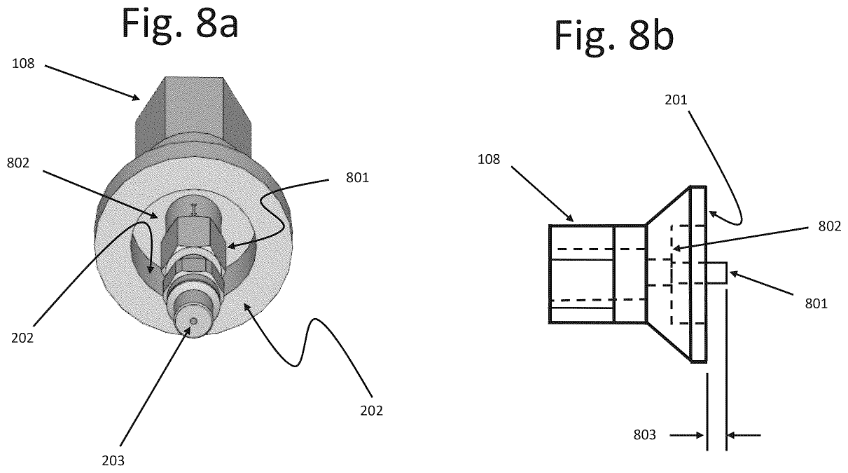

Turning to FIG. 8a and FIG. 8b, another embodiment of hose attachment 108 in accordance with the present invention is illustrated. Hose attachment 108 has attachment face 201, face inside diameter 202, and internal diameter recess 802. Hose attachment 108 includes combined spray nozzle and check valve 801 and body internal diameter 203, which is concentric with combined spray nozzle and check valve 801. Combined spray nozzle and check valve 801 extends axially from internal diameter recess 802 and extends from attachment face 201 by engagement distance of 803. In an alternative embodiment, engagement distance 803 may be negative (i.e. combined spray nozzle and check valve 801 does not extend beyond the level of attachment face 201). In another alternative embodiment, engagement distance 803 may be zero (i.e. combined spray nozzle and check valve 801 is at the level of attachment face 201). As shown in FIG. 8b, engagement distance 803 is positive (i.e. combined spray nozzle and check valve 801 extends beyond the level of attachment face 201).

Combined spray nozzle and check valve 801 may be machined into hose attachment 108, or it may be attached by means of threading, bonding, or welding. Combined spray nozzle and check valve 801 may be 3-D printed along with the entire hose attachment 108. The body of combined spray nozzle and check valve 801 improves the sealing between hose attachment 108, washer 109, and housing 101, as discussed below in FIG. 9 and FIG. 10. Combined spray nozzle and check valve 801 also the enhanced functionality of check valve 601 and spray nozzle 701 as discussed above.

Turning to FIG. 9 and FIG. 10, one embodiment of the hose attachment 108 as it connects to washer 109 and housing 101 in accordance with the present invention is illustrated. In normal operation, housing 101 is attached to vessel 902. Hose attachment 108 is positioned adjacent to washer 109, in such a way that feature 901 penetrates washer internal diameter 403 and enters nozzle internal diameter 305. Feature 901 may be nipple 501, check valve 601, spray nozzle 701, or combined spray nozzle and check valve 801. The assembly of hose attachment 108, washer 109, nozzle 104, and housing 101, are secured together by reusable clamp 106 (not shown in FIG. 9 or FIG. 10). In normal operation, hose attachment 108 is connected to coolant conduit 903. Coolant conduit 903 provides coolant 904, which is introduced into hose attachment 108. Coolant 904 passes through the above assembly and it is introduced into vessel 902. Coolant 904 may be any appropriate coolant known in the art. Coolant 904 may be liquid carbon dioxide or liquid nitrogen. Vessel 902 may be a mixer, preferably a food mixer.

It will be understood that many additional changes in the details, materials, steps and arrangement of parts, which have been herein described in order to explain the nature of the invention, may be made by those skilled in the art within the principle and scope of the invention as expressed in the appended claims. Thus, the present invention is not intended to be limited to the specific embodiments in the examples given above.

What is claimed is:

1. A nozzle attachment system, comprising:
a hose attachment comprising an attachment face, an internal diameter recess, and a hose attachment feature,
a nozzle comprising a nozzle flange, and a nozzle internal diameter, and
a housing comprising a housing flange, and a housing flange face,
wherein the nozzle is configured to fit inside the housing during assembly,
wherein the nozzle flange is configured to fit inside the internal diameter recess,
wherein the hose attachment feature is configured to fit inside the nozzle internal diameter,
wherein the nozzle flange and the housing flange are adjacent during assembly, and
wherein the attachment face and the housing flange face are adjacent during assembly.

2. The nozzle attachment system of claim 1, further comprising:
a washer comprising a first face and a second face,
the hose attachment further comprises an internal diameter recess face, and
the nozzle further comprises a nozzle flange face,
wherein the washer is located between the hose attachment and the nozzle flange,
wherein the first face is adjacent to the internal diameter recess face during assembly, and
wherein the second face is adjacent to the nozzle flange face during assembly.

3. The nozzle attachment system of claim 1, wherein the hose attachment feature is selected from the group consisting of a nipple, a check valve, a spray nozzle, and a combined spray nozzle and check valve.

4. The nozzle attachment system of claim 1, further comprising a reusable clamp configured to join the housing flange and the hose attachment in a fluid tight seal.
